(19) United States
(12) Patent Application Publication
(10) Pub. No.: US 2012/0239220 A1
(43) Pub. Date: Sep. 20, 2012

(54) SYSTEM AND METHOD FOR CONTROLLING TEMPERATURE INSIDE ENVIRONMENTAL CHAMBER

(75) Inventor: TING-CHUNG WANG, Tu-Cheng (TW)

(73) Assignee: HON HAI PRECISION INDUSTRY CO., LTD., Tu-Cheng (TW)

(21) Appl. No.: 13/157,323

(22) Filed: Jun. 10, 2011

(30) Foreign Application Priority Data
Mar. 16, 2011 (TW) 100109036

(51) Int. Cl. G05D 23/19

(52) U.S. Cl. 700/300

(57) ABSTRACT

In a method for controlling the temperature inside an environmental chamber using an electronic device, a target temperature T0, and a current internal temperature T and a current humidity level RH inside the environmental chamber are acquired. A current dew point Td of air inside the environmental chamber is calculated using a dew point calculation formula requiring the current internal temperature T and the current humidity level RH. The surface temperature of an object under test which is placed in the environmental chamber is detected using a temperature sensor. The environmental chamber is controlled according to the target temperature T0, the current internal temperature T, the current humidity level RH, and the surface temperature of the object under test.

### BACKGROUND

1. Technical Field

Embodiments of the present disclosure relate generally to the controls of environmental chambers, and more particularly, to a control system and method for controlling temperature inside an environmental chamber.

2. Description of Related Art

Electronic products, such as, notebooks and mobile phones, may be tested in an environmental chamber, to test the effects of temperature on the products. When the products need to be tested in a high temperature environment, the surface temperature of the products may rise with the rise of air temperature in the chamber. However, the air temperature may rise faster than the surface temperature of the products, which may cause water vapor in the chamber to condense on the product when its surface temperature is less than a dew point of air inside the chamber. Products may be damaged by water in them or on them.

### BRIEF DESCRIPTION OF THE DRAWINGS

FIG. 1 is a schematic diagram illustrating one example of an electronic device that is electronically connected to an environmental chamber.

FIG. 2 is a block diagram of one embodiment of the electronic device including a control system.

FIG. 3 is a flowchart of one embodiment of a method for controlling temperature inside the environmental chamber using the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

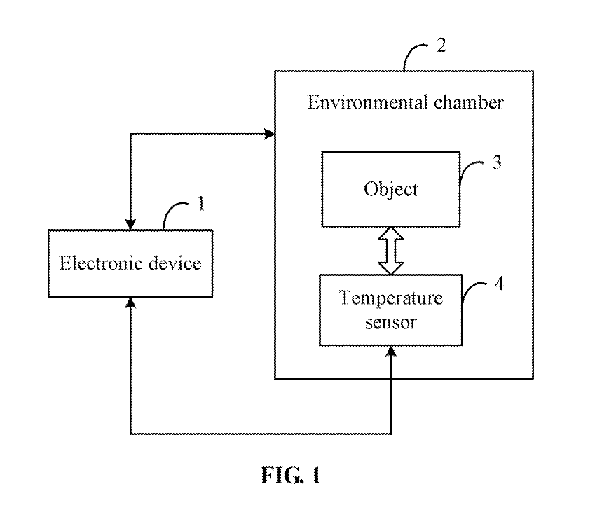

FIG. 1 is a schematic diagram illustrating one example of an electronic device 1 that is electronically connected to an environmental chamber 2. In the embodiment, an object 3 to be tested and a temperature sensor 4 are placed inside the chamber 2. The device 1 is further electronically connected to the sensor 4 which is operable to detect a surface temperature of the object 3. The sensor 4 may be placed on the surface of the object 3. The chamber 2 provides a high temperature environment for the object 3 during a testing process of the object 3. In one embodiment, the device 1 may be connected to the chamber 2 through a recommended standard 232 (RS-232) interface, to communicate with the chamber 2. The object 3 may be, for example, a notebook, a mobile phone, or other electronic product.

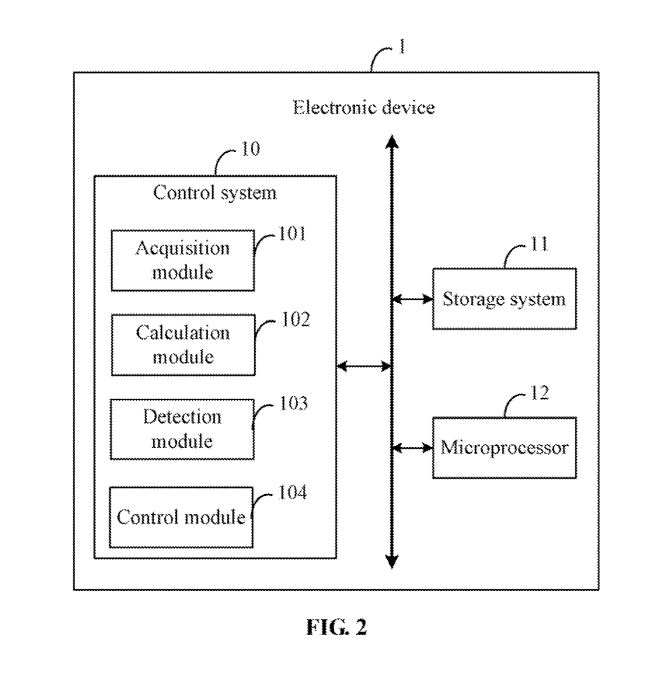

FIG. 2 is a block diagram of one embodiment of the electronic device 1 of FIG. 1. In the embodiment, the device 1 includes a control system 10, a storage system 11 and a microprocessor 12. FIG. 1 is only one example of the electronic device 1, other electronic devices 1 may include with more or less components than shown in other embodiments, or that have a different configuration of the various components.

The control system 10 may include a plurality of functional modules comprising one or more computerized instructions that are stored in the storage system 11, and executed by the microprocessor 12 to perform operations of the device 1. In the embodiment, the control system 10 includes an acquisition module 101, a calculation module 102, a detection module 103, and a control module 104. In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The acquisition module 101 is operable to acquire a target temperature T0 from the chamber 2, and acquire from the chamber 2 a current internal temperature T and a current humidity level RH inside the chamber 2. In one embodiment, the target temperature T0 may be preset by a user before the chamber 2 heats up. The object 3 may be tested inside the chamber 2 based on the temperature T0. In one embodiment, the acquisition module 101 may send commands to the chamber 2 through the RS-232 interface to acquire the temperature T0, T, and the humidity RH.

The calculation module 102 is operable to calculate a current dew point Td of air inside the chamber 2 using a dew point calculation formula according to the current internal temperature T and the current humidity level RH. The dew point is a temperature to which a given parcel of air must be cooled, at a constant barometric pressure, for water vapor to condense into water. Therefore, when the surface temperature of the object 3 is less than the dew point of the air inside the chamber 2, water may condense out of the air onto or into the object 3. In one embodiment, the dew point calculation formula is

$$Td = \frac{b \times λ ( T , RH )}{a - λ ( T , RH )} ,$$

where a=17.27, b=237.7° C., and

$$λ ( T , RH ) = \frac{aT}{b + T} + ln \frac{RH}{100} .$$

The detection module 103 is operable to detect a current surface temperature T1 of the object 3 using the sensor 4, and determine whether the current surface temperature T1 has reached the target temperature T0.

The control module 104 is operable to determine whether the current surface temperature T1 is less than a sum of the current dew point Td and a predetermined temperature Tp. In one embodiment, the temperature Tp is greater than 0° C., but can not larger than, for example, 5° C.

The temperature T1 is regarded as being close to the current dew point Td when T1 is less than the sum of Td and Tp. If the chamber 3 continues to heat up, the actual dew point of the air in the chamber may rise instantaneously, which may cause the water vapor to condense even if the current surface temperature T1 of the object 3 has risen above the original figure for the dew point. Therefore, the control module 104 is further operable to control the chamber 2 to suspend a chamber heating process of the chamber 2 until the current surface temperature T1 has risen to equal the sum of Td and Tp if T1 is less than the sum of Td and Tp, or control the chamber 2 to continue or resume the chamber heating process if T1 is equal to or greater than the sum of Td and Tp.

In addition, when the current surface temperature T1 of the object 3 has reached the target temperature T0, the control module 104 is further operable to trigger the chamber 2 to send out a notification to the user, so that the user may begin testing the object 3.

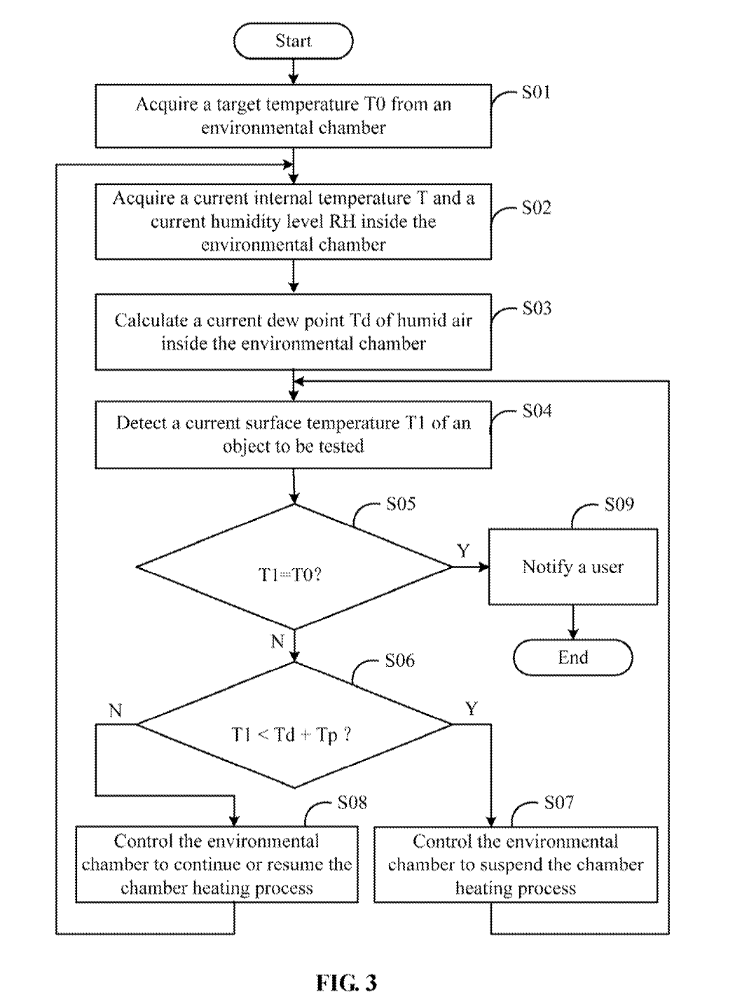

FIG. 3 is a flowchart of one embodiment of a method for controlling temperature inside the environmental chamber using the electronic device 1 of FIG. 1. Depending on the embodiment, additional blocks may be added, others removed, and the ordering of the blocks may be changed.

In block S01, the acquisition module 101 acquires a target temperature T0 from the chamber 2. The target temperature T0 may be preset by a user before the chamber 2 starts to heat up. In block S02, the acquisition module 101 acquires from the chamber 2 a current internal temperature T and a current humidity level RH inside the chamber 2. In one embodiment, the acquisition module 101 may send commands to the chamber 2 to acquire the temperatures T0, and T, and the humidity RH.

In block S03, the calculation module 102 calculates a current dew point Td of air inside the chamber 2 using a dew point calculation formula according to the current internal temperature T and the current humidity level RH. In one embodiment, the dew point calculation formula is

$$Td = \frac{b \times λ ( T , RH )}{a - λ ( T , RH )} ,$$

where a=17.27, b=237.7° C., and

$$λ ( T , RH ) = \frac{aT}{b + T} + ln \frac{RH}{100} .$$

In block S04, the detection module 103 detects a current surface temperature T1 of the object 3 using the sensor 4. The current surface temperature T1 will rise towards the target temperature T0 during the heating of the chamber 2.

In block S05, the detection module 103 determines whether the current surface temperature T1 has reached the target temperature T0. If the current surface temperature T1 has reached the target temperature T0, block S09 is implemented. Otherwise, if the current surface temperature T1 has not reached the target temperature T0, block S06 is implemented.

In block S06, the control module 104 determines whether the current surface temperature T1 is less than a sum of the current dew point Td and a predetermined temperature Tp. If T1 is less than the sum of Td and Tp, block S07 is implemented. Otherwise, if T1 is not less than the sum of Td and Tp, block S08 is implemented. In one embodiment, the temperature Tp is greater than 0° C., and less than 5° C.

In block S07, the control module 104 controls the chamber 2 to suspend a chamber heating process of the chamber 2, and the procedure returns to block S04.

In block S08, the control module 104 controls the chamber 2 to continue or resume the chamber heating process, and the procedure returns to block S02.

In block S09, the control module 104 triggers the chamber 2 to notify the user that the current surface temperature T1 of the object 3 has reached the target temperature T0, so that the user may test the object 3 in temperature T0.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for controlling temperature inside an environmental chamber using an electronic device, the electronic device being electronically connected to a temperature sensor positioned inside the environmental chamber, the method comprising:
(a) acquiring a target temperature T0 from the environmental chamber;
(b) acquiring, from the environmental chamber, a current internal temperature T and a current humidity level RH inside the environmental chamber;
(c) calculating a current dew point Td of air inside the environmental chamber using a dew point calculation formula according to the current internal temperature T and the current humidity level RH;
(d) detecting a current surface temperature T1 of an object that is placed in the environmental chamber using the temperature sensor; and
(e) determining whether the current surface temperature T1 has reached the target temperature T0;
upon the condition that the current surface temperature T1 has reached the target temperature T0, triggering the environmental chamber to notify a user; or
upon the condition that the current surface temperature T1 has not reached the target temperature T0, implementing the following step (f) to step (h):
(f) determining whether the current surface temperature T1 is less than a sum of the current dew point Td and a predetermined temperature Tp;
(g) controlling the environmental chamber to suspend a chamber heating process of the environmental chamber until the current surface temperature T1 has reached the sum of Td and Tp, if the current surface temperature T1 is less than the sum of Td and Tp; or
(h) controlling the environmental chamber to continue or resume the chamber heating process if the current surface temperature T1 is not less than the sum of Td and Tp.

2. The method according to claim 1, wherein the electronic device is electronically connected to the environmental chamber through a recommended standard 232 (RS-232) interface to communicate with the environmental chamber.

3. The method according to claim 2, wherein the target temperature T0, the current internal temperature T, and the current humidity level RH are acquired by sending commands to the environmental chamber through the RS-232 interface.

4. The method according to claim 1, wherein the dew point calculation formula is
$$Td = \frac{b \times λ ( T , RH )}{a - λ ( T , RH )} ,$$
where a=17.27, b=237.7° C., and
$$λ ( T , RH ) = \frac{aT}{b + T} + ln \frac{RH}{100} .$$

5. The method according to claim 1, wherein the predetermined temperature Tp is greater than 0° C. and less than 5° C.

6. The method according to claim 1, wherein the target temperature T0 is preset by a user before the environmental chamber starts to heat up.

7. An electronic device for controlling temperature inside an environmental chamber, the electronic device being electronically connected to a temperature sensor positioned inside the environmental chamber, electronic device comprising:
at least one microprocessor;
a storage system; and
one or more programs stored in the storage system and being executable by the at least one microprocessor, the one or more programs comprising:
an acquisition module operable to acquire, from the environmental chamber, a target temperature T0, and a current internal temperature T and a current humidity level RH inside the environmental chamber;
a calculation module operable to calculate a current dew point Td of air inside the environmental chamber using a dew point calculation formula according to the current internal temperature T and the current humidity level RH;
a detection module operable to detect a current surface temperature T1 of an object that is placed in the environmental chamber using the temperature sensor, and determine whether the current surface temperature T1 has reached the target temperature T0; and
a control module operable to determine whether the current surface temperature T1 is less than a sum of the current dew point Td and a predetermined temperature Tp if the current surface temperature T1 has not reached the target temperature T0, and control the environmental chamber to suspend a chamber heating process of the environmental chamber until the current surface temperature T1 has reached the sum of Td and Tp if the current surface temperature T1 is less than the sum of Td and Tp, or control the environmental chamber to continue or resume the chamber heating process if the current surface temperature T1 is not less than the sum of Td and Tp.

8. The electronic device according to claim 7, wherein the control module further operable to trigger the environmental chamber to notify a user, if the current surface temperature T1 has reached the target temperature T0.

9. The electronic device according to claim 7, wherein the electronic device is electronically connected to the environmental chamber through a recommended standard 232 (RS-232) interface to communicate with the environmental chamber.

10. The electronic device according to claim 9, wherein the target temperature T0, the current internal temperature T, and the current humidity level RH are acquired by sending RS 232 commands to the environmental chamber through the RS-232 interface.

11. The electronic device according to claim 7, wherein the dew point calculation formula is
$$Td = \frac{b \times λ ( T , RH )}{a - λ ( T , RH )} ,$$
where a=17.27, b=237.7° C., and
$$λ ( T , RH ) = \frac{aT}{b + T} + ln \frac{RH}{100} .$$

12. The electronic device according to claim 7, wherein the predetermined temperature Tp is greater than 0° C. and less than 5° C.

13. The electronic device according to claim 7, wherein the target temperature T0 is preset by a user before the environmental chamber starts to heat up.

14. A non-transitory storage medium storing a set of instructions, the set of instructions capable of being executed by a microprocessor of an electronic device, to perform a method for controlling temperature inside an environmental chamber, the electronic device being electronically connected to a temperature sensor positioned inside the environmental chamber, the method comprising:
(a) acquiring a target temperature T0 from the environmental chamber;
(b) acquiring, from the environmental chamber, a current internal temperature T and a current humidity level RH inside the environmental chamber;
(c) calculating a current dew point Td of air inside the environmental chamber using a dew point calculation formula according to the current internal temperature T and the current humidity level RH;
(d) detecting a current surface temperature T1 of an object that is placed in the environmental chamber using the temperature sensor; and
(e) determining whether the current surface temperature T1 has reached the target temperature T0;
upon the condition that the current surface temperature T1 has reached the target temperature T0, triggering the environmental chamber to notify a user; or
upon the condition that the current surface temperature T1 has not reached the target temperature T0, implementing the following step (f) to step (h):
(f) determining whether the current surface temperature T1 is less than a sum of the current dew point Td and a predetermined temperature Tp;
(g) controlling the environmental chamber to suspend a chamber heating process of the environmental chamber until the current surface temperature T1 has reached the sum of Td and Tp, if the current surface temperature T1 is less than the sum of Td and Tp; or
(h) controlling the environmental chamber to continue or resume the chamber heating process if the current surface temperature T1 is not less than the sum of Td and Tp.

15. The storage medium as claimed in claim 14, wherein the electronic device is electronically connected to the environmental chamber through a recommended standard 232 (RS-232) interface to communicate with the environmental chamber.

16. The storage medium as claimed in claim 15, wherein the target temperature T0, the current internal temperature T, and the current humidity level RH are acquired by sending RS 232 commands to the environmental chamber through the RS-232 interface.

17. The storage medium as claimed in claim 14, wherein the dew point calculation formula is
$$Td = \frac{b \times λ ( T , RH )}{a - λ ( T , RH )} ,$$
where a=17.27, b=237.7° C., and
$$λ ( T , RH ) = \frac{aT}{b + T} + ln \frac{RH}{100} .$$

18. The storage medium as claimed in claim 14, wherein the predetermined temperature Tp is greater than 0° C. and less than 5° C.

19. The storage medium as claimed in claim 14, wherein the target temperature T0 is preset by a user before the environmental chamber starts to heat up.
